(19) United States
(12) Patent Application Publication
(10) Pub. No.: US 2026/0229227 A1
(43) Pub. Date: Aug. 6, 2026

(54) LARGE LANGUAGE MODEL-PREDICTED RESPONSE BIASING FOR CONVERSATIONAL SYSTEMS

(71) Applicant: Google LLC, Mountain View, CA (US)

(72) Inventors: Petar Stanisa Aleksic, Hawthorne, NJ (US); Lillian Qiaohui Zhou, Mountain View, CA (US)

(73) Assignee: Google LLC, Mountain View, CA (US)

(21) Appl. No.: 19/462,632

(22) Filed: Jan. 28, 2026

Related U.S. Application Data
(60) Provisional application No. 63/752,407, filed on Jan. 31, 2025.

(51) Int. Cl. G10L 15/16; G06N 3/0455; G10L 15/08; G10L 15/22

(52) U.S. Cl. CPC G10L 15/16; G06N 3/0455; G10L 15/22; G10L 2015/088

(57) ABSTRACT

A method includes receiving a response generated by an assistant LLM that is directed toward the user during an assistant turn in conversation between a user and the assistant LLM. Based on the response generated by the assistant LLM, the method also includes predicting, by the assistant LLM, one or more possible terms the user may speak in a follow-up query to the response generated by the assistant LLM. The method also includes biasing an automated speech recognition (ASR) model toward recognizing the one or more possible terms predicted by the assistant LLM, receiving audio data characterizing the follow-up query to the response generated by the assistant LLM during the user turn subsequent to the assistant turn in the voice-based conversation, and processing, using the ASR model biased toward recognizing the one or more possible terms, the audio data to generate a transcription of the follow-up query.

### TECHNICAL FIELD

U.S. Patent application claims priority under 35 U.S.C. § 119(e) to U.S. Provisional Application 63/752,407, filed on Jan. 31, 2025. The disclosure of this prior application is considered part of the disclosure of this application and is hereby incorporated by reference in its entirety.

### TECHNICAL FIELD

This disclosure relates to large language model-predicted response biasing for conversational systems.

### BACKGROUND

Conversational systems leveraging large language models (LLMs) as chatbots/assistants can allow voice-based conversations where a user can speak a query directed toward the LLM, listen to an audio-based response to the query returned from the LLM, and continue the voice-based conversation with the LLM. Often, these conversational systems include a cascaded architecture where an automated speech recognition (ASR) model is responsible for transcribing user speech into text, and then the ASR model sends the text to the LLM for processing to generate a response to the query. The cascaded architecture may further include a text-to-speech (TTS) system that converts a textual representation of the response generated by the LLM into TTS audio that conveys the response as synthesized speech for playback to the user.

In these cascaded architectures where a separate ASR model is responsible for providing the transcription of the user speech to the LLM, the ASR model lacks context from earlier in the conversation to produce the most accurate transcription. While the LLM itself may have a very clear prediction of what form the user's speech may take, the ASR model that will be transcribing the user's speech is agnostic to this information.

### DESCRIPTION OF DRAWINGS

FIG. 1 is a schematic view of a system for biasing a speech recognition model when transcribing user speech in a voice-based conversation between the user and an assistant large language model (LLM).

recognition during a voice-based conversation between a user and a large language model (LLM)-powered assistant.

FIG. 2 is a schematic view of an example speech recognition model having a recurrent neural network-transducer architecture.

FIGS. 3A-3C are schematic views of user and assistant turns during a voice-based conversation between a user and an assistant LLM.

FIG. 4 includes a flowchart of an example arrangement of operations for a computer-implemented method of biasing an ASR model during a voice-based conversation between the user and the assistant LLM.

FIG. 5 is a schematic view of an example computing device that may be used to implement the systems and methods described herein.

Like reference symbols in the various drawings indicate like elements.

### SUMMARY

One aspect of the present disclosure provides a computer-implemented method executing on data processing hardware that causes the data processing hardware to perform operations that include, during an assistant turn in a voice-based conversation between a user and an assistant large language model (LLM), receiving a response generated by the assistant LLM that is directed toward the user, and based on the response generated by the assistant LLM that is directed toward the user, predicting, by the assistant LLM, one or more possible terms the user may speak in a follow-up query to the response generated by the assistant LLM during a user turn subsequent to the assistant turn in the voice-based conversation. The operations also include biasing an automated speech recognition (ASR) model toward recognizing the one or more possible terms predicted by the assistant LLM; during the user turn subsequent to the assistant turn in the voice-based conversation, receiving audio data characterizing the follow-up query to the response generated by the assistant LLM; and processing, using the ASR model biased toward recognizing the one or more possible terms predicted by the assistant LLM, the audio data to generate a transcription of the follow-up query.

Implementations of the disclosure may include one or more of the following optional features. In some implementations, predicting the one or more possible terms the user may speak in the follow-up query includes processing a textual representation of the response to: determine that the response directed toward the user comprises a question that solicits the user to speak an answer to the question; and identify a list of likely answers to the question, and determining the one or more possible terms the user may speak in the follow-up query as the list of likely answers to the question. In other implementations, predicting the one or more possible terms the user may speak in the follow-up query includes: processing a textual representation of the response to determine the response includes a question directed toward the user that solicits the user to speak a first term or a second term in the follow-up query; and determining the one or more possible terms the user may speak in the follow-up query comprises the first term and the second term. In these other implementations, the first term may include one of Yes or No, and the second term may include the other one of Yes or No. Further, the response including the question directed toward the user may solicit the user to speak the first term or the second term without specifying the first term and the second term in the response.

In some examples, the operations also include obtaining, from the assistant LLM, a conversation history of the voice-based conversation comprising all previous queries input by the user and corresponding responses returned by the assistant LLM during the voice-based conversation. In these examples, biasing the ASR model toward recognizing the one or more possible terms predicted by the assistant LLM further includes biasing the ASR model toward recognizing biasing terms related to the conversation history of the voice-based conversation. Here, the one or more possible terms predicted by the assistant LLM may be different from the biasing terms related to the conversation history.

In some implementations, the operations also include, after generating the transcription of the follow-up query, processing, by the assistant LLM, the transcription of the follow-up query to generate another response directed toward the user that is responsive to the follow-up query. Additionally or alternatively, the operations may also include processing, by a text-to-speech (TTS) system, a textual representation of the response generated by assistant LLM to generate TTS audio characterizing a synthesized speech representation of the response, and providing, for audible output from a user device associated with the user, the TTS audio characterizing the synthesized speech representation of the response. The ASR model may include an acoustic encoder and a speech decoder, while the assistant LLM may include a plurality of pre-trained multi-head attention layers. The ASR model and the plurality of pre-trained multi-head attention layers may be trained separately.

Another aspect of the present disclosure includes a system having data processing hardware and memory hardware in communication with the data processing and storing instructions that when executed on the data processing hardware causes the data processing hardware to perform operations. The operations include, during an assistant turn in a voice-based conversation between a user and an assistant large language model (LLM), receiving a response generated by the assistant LLM that is directed toward the user, and based on the response generated by the assistant LLM that is directed toward the user, predicting, by the assistant LLM, one or more possible terms the user may speak in a follow-up query to the response generated by the assistant LLM during a user turn subsequent to the assistant turn in the voice-based conversation. The operations also include biasing an automated speech recognition (ASR) model toward recognizing the one or more possible terms predicted by the assistant LLM; during the user turn subsequent to the assistant turn in the voice-based conversation, receiving audio data characterizing the follow-up query to the response generated by the assistant LLM; and processing, using the ASR model biased toward recognizing the one or more possible terms predicted by the assistant LLM, the audio data to generate a transcription of the follow-up query.

This aspect may include one or more of the following optional features. In some implementations, predicting the one or more possible terms the user may speak in the follow-up query includes processing a textual representation of the response to: determine that the response directed toward the user comprises a question that solicits the user to speak an answer to the question; and identify a list of likely answers to the question, and determining the one or more possible terms the user may speak in the follow-up query as the list of likely answers to the question. In other implementations, predicting the one or more possible terms the user may speak in the follow-up query includes: processing a textual representation of the response to determine the response includes a question directed toward the user that solicits the user to speak a first term or a second term in the follow-up query; and determining the one or more possible terms the user may speak in the follow-up query comprises the first term and the second term. In these other implementations, the first term may include one of Yes or No, and the second term may include the other one of Yes or No. Further, the response including the question directed toward the user may solicit the user to speak the first term or the second term without specifying the first term and the second term in the response.

In some examples, the operations also include obtaining, from the assistant LLM, a conversation history of the voice-based conversation comprising all previous queries input by the user and corresponding responses returned by the assistant LLM during the voice-based conversation. In these examples, biasing the ASR model toward recognizing the one or more possible terms predicted by the assistant LLM further includes biasing the ASR model toward recognizing biasing terms related to the conversation history of the voice-based conversation. Here, the one or more possible terms predicted by the assistant LLM may be different from the biasing terms related to the conversation history.

In some implementations, the operations also include, after generating the transcription of the follow-up query, processing, by the assistant LLM, the transcription of the follow-up query to generate another response directed toward the user that is responsive to the follow-up query. Additionally or alternatively, the operations may also include processing, by a text-to-speech (TTS) system, a textual representation of the response generated by assistant LLM to generate TTS audio characterizing a synthesized speech representation of the response, and providing, for audible output from a user device associated with the user, the TTS audio characterizing the synthesized speech representation of the response. The ASR model may include an acoustic encoder and a speech decoder, while the assistant LLM may include a plurality of pre-trained multi-head attention layers. The ASR model and the plurality of pre-trained multi-head attention layers may be trained separately.

The details of one or more implementations of the disclosure are set forth in the accompanying drawings and the description below. Other aspects, features, and advantages will be apparent from the description and drawings, and from the claims.

### DETAILED DESCRIPTION

Humans may engage in human-to-computer dialogs with interactive software applications referred to as “chatbots,” “voice bots”, “automated assistants”, “interactive personal assistants,” “intelligent personal assistants,” “conversational agents,” etc. via a variety of computing devices. As one example, these chatbots may correspond to a machine learning model or a combination of different machine learning models, and may be utilized to perform various tasks on behalf of users.

Chatbots adopting Large language models (LLMs) are currently opening up a wide range of applications due to their powerful understanding and generation capabilities which can operate over text, image, and/or audio inputs. These models are also being extended with actuation capabilities via integration mechanisms with various service providers.

Automatic speech recognition (ASR) systems focus on providing not only high quality (e.g., a low word error rate), but also low latency (e.g., a short delay between a user speaking and a transcription or response appearing) speech recognition for spoken utterances. For example, when using a device that implements an ASR system, there is often an expectation that the ASR system decodes utterances in a streaming fashion that corresponds to real-time or even faster than real-time.

Conversational applications (e.g., digital assistants, chatbots, voice-controlled applications, etc.) leveraging large language models (LLMs) have become more popular in recent years. Recently, the use of LLMs in conversational applications have been adapted to accept speech from a user that solicits a response from the LLM, and the conversational application in turn can provide the response generated by the LLM for audible output from a user device. These conversational applications adapted for voice-based conversations may leverage a cascaded architecture that includes an ASR model for transcribing user speech into text and the LLM for processing the text transcribed by the ASR model to generate a response. The cascaded architecture may further include a text-to-speech (TTS) system that converts a textual representation of the response generated by the LLM into TTS audio that conveys the response as synthesized speech. For instance, the user device can use a microphone to capture a natural language utterance spoken by the user, the ASR model can convert the spoken natural language utterance into text, the LLM extracts the user's intent from the text and generates a textual response based on the user's intent, and the TTS system converts the textual response into synthesized speech for audible output from the user device. In some scenarios, the ASR model includes an audio encoder that first encodes audio data characterizing the spoken input and a decoder that decodes the encoded audio data into text to form the transcription.

The LLM may maintain a conversation history of the voice-based conversation between the user that conveys the transcriptions of the natural language utterances spoken by the user and the corresponding textual responses generated by the LLM. The conversational application may use the conversation history to bias the ASR model toward recognizing biasing terms conveyed earlier in the conversation history to contextualize the transcription of user speech during a current user turn in the voice-based conversation. However, after the LLM generates a response during an assistant turn in the voice-based conversation, the LLM may be able to ascertain a very clear prediction of what form the user's speech may take in a follow-up query to the response that is not available to the ASR model that will be transcribing the user's speech.

Implementations herein are directed toward leveraging the LLM to predict possible terms a user may speak during a next user turn in a voice-based conversation between the user and an assistant LLM based on a response generated by the LLM during an assistant turn in the voice-based conversation and using the possible terms predicted by the LLM to bias the ASR model toward recognizing the possible terms in speech spoken by the user during the next user turn. Specifically, the conversational application may receive a response generated by the assistant LLM that is directed toward the user during an assistant turn in the voice-based conversation, and based on the response, the LLM may predict one or more possible terms the user may speak in a follow-up query to the response generated by the assistant LLM during a user turn subsequent to the assistant turn in the voice-based conversation. Thereafter, the conversational application may bias the ASR model toward recognizing the one or more possible terms predicted by the assistant so that when the conversational application receives audio data characterizing the follow-up query during the user turn subsequent to the assistant turn in the voice-based conversational application, the ASR model biased toward recognizing the one or more possible terms predicted by the assistant LLM may process the audio data to generate an accurate transcription of the follow-up query.

Notably, while the ASR model may optionally be further biased toward recognizing biasing terms related to a conversation history of the voice-based conversation maintained by the assistant LLM, these biasing terms relate to entities previously recited during the conversation history, and are thus, different than the one or more possible terms that the LLM predicts the user is likely to speak in the follow-query based on the response generated by the LLM. For instance, the LLM may determine that the response includes a question directed toward the user that solicits the user to speak “Yes” or “No” as an answer to the question. Here, the LLM may predict the terms “Yes” and “No” as possible terms the user is likely to speak in a follow-up query for use in biasing the ASR model toward recognizing the terms “Yes” and “No” when the user speaks the follow-up query to the response during the next user turn. Accordingly, these possible terms the user is likely to speak are predicted by the LLM based on the most recent response generated by the LLM and are not terms ascertainable from the conversation history nor are they included or otherwise specified in the most recent response generated by the LLM.

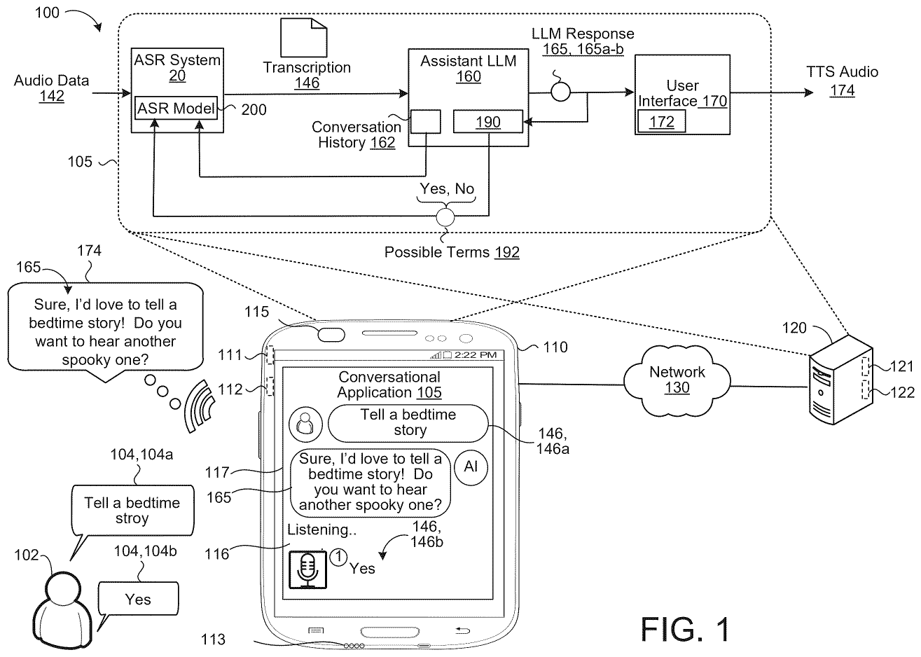

FIG. 1 illustrates an example system 100 for allowing a spoken conversation between a user 102 and an assistant LLM 160. The assistant LLM 160 may be interchangeably referred to as an “LLM-powered assistant 160”, “LLM 160”, or “assistant 160”. A conversational assistant application 105 may execute on a user device 110 associated with the user 102 to enable the user 102 and the LLM-powered assistant 160 to interact with one another through spoken conversation. The conversational assistant application 105 may access various components for facilitating the spoken conversation in a natural manner between the user 102 and the LLM-powered assistant 160. For instance, through the use of application programming interfaces (APIs) or other types of plug-ins, the conversation assistant application 105 may access a cascaded architecture that includes an automated speech recognition (ASR) system 20 including an ASR model 200, the LLM-powered assistant 160, and a user interface 170 including a text-to-speech (TTS) system 172.

During a user turn of the spoken conversation between the user 102 and the LLM-powered assistant 160, the user device 110 captures audio data 142 characterizing an utterance of a natural language query 104 spoken by the user 102 and directed toward the assistant 160 to solicit a response 165 from the assistant 160. For instance, the query 104 may specify a particular task that the user 102 would like the assistant 160 to perform, or may specify a particular question that the user 102 would like the assistant 160 to answer and the assistant 160 may generate a response 165 that answers the question. The query 104 may similarly correspond to a request for information and the assistant 160 may generate a response 165 conveying the requested information. While the term query 104 is used, the query 104 may correspond to any natural language dialog (e.g., a greeting) directed toward the LLM-powered assistant 160 during the user's turn in the spoken conversation between the user 102 and the LLM-powered assistant 160. The user 102 may speak the utterance of the query 104 in natural language and the ASR system 20 may perform speech recognition on the audio data 142 characterizing the utterance of the query 104 to generate a transcription 146 for the query 104 spoken by the user 102. Thereafter, the ASR system 20 feeds the transcription 146 for the query 104 to the LLM-powered assistant 160 to enable the LLM-powered assistant 160 to perform the task of generating a response 165 to the user's query 104. The conversational application 105 may display a digital assistant interface 116 on a screen 117 of the user device 110 to depict a conversation history 162 of dialog turns for the conversation between the user 10 and the LLM-powered assistant 160. The assistant LLM 160 may maintain the conversation history 162 for use as context during the voice-based conversation.

The system 100 includes the user device 110, a remote computing system 120, and a network 130. The user device 110 includes data processing hardware 111 and memory hardware 112. The user device 110 may include, or be in communication with, an audio capture device 113 (e.g., an array of one or more microphones) for converting utterances of natural language queries 104 spoken by the user 10 into corresponding audio data 102 (e.g., electrical signals or digital data). In scenarios when the user speaks a natural language query 104 captured by the microphone 113 of the user device 110, the ASR system 20 executing on the user device 110 or the remote computing system 120 may process the corresponding audio data 102 to generate a transcription 146 of the query 104. Here, the transcription 104 conveys the textual query 104 provided as input to the assistant LLM 160.

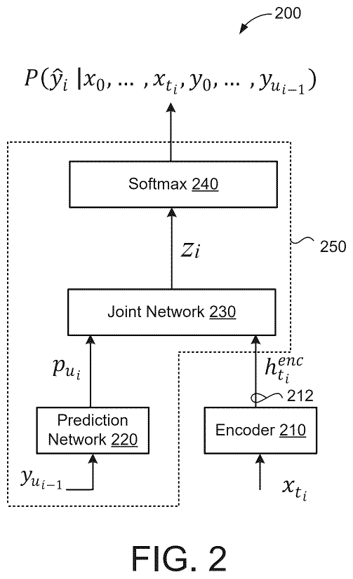

The ASR system 20 includes the ASR model 210. The ASR model 200 may implement any number and/or type(s) of past, current, or future speech recognition systems, models and/or methods including, but not limited to, an end-to-end speech recognition model, such as streaming speech recognition models having recurrent neural network-transducer (RNN-T) model architectures other frame alignment-based transducer model architectures which adhere to latency constraints associated with interactive applications, a hidden Markov model, an acoustic model, a pronunciation model, a language model, and/or a naïve Bayes classifier. In some examples, the ASR model 200 includes an audio encoder 210 (FIG. 2) and a speech decoder 250 for decoding audio encodings 212 output by the audio encoder 210 into speech recognition results that form the transcription 146.

Referring to FIG. 2, an example frame alignment-based transducer model 200 includes a Recurrent Neural Network-Transducer (RNN-T) model architecture is shown. The use of the RNN-T model architecture is exemplary, and the frame alignment-based transducer model 200 may include other architectures such as transformer-transducer and conformer-transducer model architectures among others. The RNN-T model 200 provides a small computational footprint and utilizes less memory requirements than conventional ASR architectures, making the RNN-T model architecture suitable for performing speech recognition entirely on the user device 110 (e.g., no communication with a remote server is required). The RNN-T model 200 includes the audio encoder 210, a prediction network 220, and a joint network 230. The audio encoder 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the audio encoder 210 reads a sequence of d-dimensional feature vectors (e.g., audio frames 102 (FIG. 1) x=(x₁, x₂, . . . , x_{T}), where xₜ∈ [symbol] _{d}, and produces at each output step a higher-order feature representation. This higher-order feature representation is denoted as

$${h}_{1}^{e n c} , … , {h}_{T}^{e n c}$$

and may be interchangeably referred to as an audio encoding 212.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations.

The joint network then predicts P(yᵢ|xₜ_{ᵢ}, y₀, . . . , yᵤ_{ᵢ₋₁}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics but also on the sequence of labels output so far. The RNN-T model 200 does assume an output symbol is independent of future acoustic frames 102, which allows the RNN-T model to be employed in a streaming fashion.

In some examples, the audio encoder 210 of the RNN-T model 200 includes a stack of self-attention layers/blocks, such as conformer layers/blocks. In some examples, the number of conformer layers/blocks in the audio encoder is equal to 17 with 512-dimensional layers. The audio encoder 210 may include 100 million parameters. Here, each conformer block includes a series of multi-headed self attention, depth wise convolution and feed-forward layers. The stack of self-attention layers/blocks may include transformer layers/blocks in other examples. The prediction network 220 may have one 512-dimensional LSTM layer. Alternatively, the prediction network 220 may include a stack of transformer or conformer blocks, or an embedding look-up table in lieu of LSTM layers. Finally, the joint network 230 may include two (2) feedforward layers with a 512-dimensional intermediate layer. The Softmax layer 240 may be composed of a unified word piece or grapheme set that is generated using all unique word pieces or graphemes in a plurality of training data sets. The Softmax layer 240 may include a 1024-dimensional layer corresponding to 1,024 wordpiece targets. The prediction network 220, the joint network 230, and the Softmax layer 240 may collectively form an RNN-T decoder 250 of the RNN-T model 200. Thus, the speech decoder 250 of FIG. 1 may include the RNN-T decoder 250

Referring back to FIG. 1, the microphone 113 of the user device 110 may remain always-on or open during the conversation between the user 102 and the LLM-powered assistant 160 to permit the conversational application 105 to always accept speech spoken by the user 102, thereby providing a more natural dialog between the user 102 and the assistant 160. For instance, the user 102 may barge-in through speech directed toward the LLM-powered assistant 160 even during times when the conversational application 105 is audibly outputting, from an audio output device (e.g., speaker) 115 of the user device 110, text-to-speech (TTS) audio 174 characterizing a response 165 generated by the LLM-powered assistant 160.

The user device 110 may be any computing device capable of communicating with the remote computing system 120 through the network 130. The user device 110 includes, but is not limited to, desktop computing devices and mobile computing devices, such as laptops, tablets, smart phones, smart speakers/displays, digital assistant devices, smart appliances, internet-of-things (IoT) devices, infotainment systems, vehicle infotainment systems, and wearable computing devices (e.g., headsets, smart glasses, and/or watches).

The remote computing system 120 may be a distributed system (e.g., a cloud computing environment) having scalable elastic resources. The resources include computing resources 121 (e.g., data processing hardware) and/or storage resources 122 (e.g., memory hardware). Additionally or alternatively, the remote computing system 120 may be a centralized system. The network 130 may be wired, wireless, or a combination thereof, and may include private networks and/or public networks, such as the Internet.

The components leveraged by the conversational assistant application 105 may execute on the data processing hardware 111 of the user device 110 or on the data processing hardware 121 of the remote computing system 120. In some implementations, the components leveraged by the conversational assistant application 105 executes on both the data processing hardware 111 of the user device 110 and the data processing hardware 121 of the remote computing system 120. For instance, one or more components of the conversational assistant application 105 may execute on the data processing hardware 111 of the user device 110 while one or more other components of the conversational assistant application 105 may execute on the remote computing system 120.

The LLM-powered assistant 160 assistant may power the conversational assistant application 105 to function as a personal chat bot capable of having dialog conversations with the user 102 in natural language and performing tasks/actions on the user's behalf. In some examples, the LLM-powered assistant 160 includes an instance of Gemini, LaMDA, BERT, Meena, ChatGPT, Grok, or any other previously trained LLM. These previously trained LLMs have been previously trained on enormous amounts of diverse data and are capable of engaging in corresponding conversations with users in a natural and intuitive manner. However, these LLMs have a plurality of machine learning (ML) layers and hundreds of millions to hundreds of billions of ML parameters. The LLM-powered assistant 160 includes a stack of multi-head attention layers. In some examples, the stack of multi-head attention layers include Transformer layers. However, the LLM-powered assistant 160 may include other types of multi-head attention layers without departing from the scope of the present disclosure.

The conversational assistant application 105 is configured to provide, for output from the user device 110, the response 165 generated by the LLM-powered assistant 160. Here, the user interface 170 may audibly output, from an audio output device (e.g., acoustic speaker) 115, text-to-speech (TTS) audio 174 that conveys the response 165 as synthesized speech. For instance, the user interface 170 may include a text-to-speech (TTS) system 172 that converts a textual representation of the response 165 into TTS audio 174 conveying the response 165 as synthesized speech. Here, the TTS system 172 may include a TTS model that converts the textual representation of the response into synthesized speech representations (e.g., Mel-frequency spectrograms) and a vocoder that convers the synthesized speech representation into time-domain audio that may be audibly output from the user device 110 as synthesized speech. Additionally or alternatively, the conversational assistant application 105 may instruct the user interface 170 to display, on the screen 117 in communication with the user device 110, text representing the response 165. In the example shown, the user speaks a first natural query 104, 104a of “Tell a bedtime story” and the LLM-powered assistant 160 generates the response 165 of “Sure, I'd love to tell a bedtime story! Do you want to hear another spooky one?”, which may be audibly output as TTS audio 174 and/or displayed in text on the screen 117. Notably, the user interface 170 may display the conversational history 162 of queries 104 and responses 165 during the spoken conversation between the user 102 and the assistant 160. The LLM-powered assistant 160 may maintain the conversation history 162 for use as context for generating responses 165 and may provide the conversation history 162 to the ASR model 200 for contextualizing transcriptions generated by the ASR model 200. For instance, the conversation history 162 may include biasing terms that were recited in the previous queries 104 and responses 165 during the voice-based conversation and the conversational application may bias the ASR model 200 toward recognizing the biasing terms in user speech during the user's turn.

Continuing with the example in FIG. 1, after the assistant LLM 160 generates the response 165 during the assistant term, the assistant LLM 160 may implement a predictor 190 that further processes the response 165 (i.e., a textual representation of the response) to predict one or more possible terms 192 the user 102 may speak, during a next user turn in the voice-based conversation, in a follow-up query 104, 104b to the response 165 generated by the LLM 160. In some examples, parameter efficient fine-tuning (PEFT) is applied to fine-tune a small subset of parameters or individual multi-head attention layers of the assistant LLM 160 to implement the predictor 190 for predicting possible terms 192 from a LLM-generated response. In these examples, the conversational application 105 activates the small subset of parameters or individual multi-head attention layers to implement the predictor 190 responsive to the assistant LLM 160 generating the response 165 so that the predictor 190 can process the response 165 to predict the one or more possible terms 192 that the user may speak in the follow-up query 104, 104b to the response 165. Optionally, the predictor 190 may include a separate LLM 160 that is trained to predict possible terms that a user is likely to speak in a follow-up query to an LLM-generated response. In the example of FIG. 1, the assistant LLM 160 processes the textual representation of the response 165 to determine that the response 165 includes a question directed toward the user 102 that solicits the user 102 to speak a first term (e.g. Yes) or a second term (e.g., No) in the follow-up query and determines the one or more possible terms the user may speak in the follow-up query as the first term (e.g., Yes) and the second term (e.g., No). For instance, the assistant LLM 160 provides the first term (Yes) and the second term (No) as the predicted possible terms 192 for biasing the ASR model toward recognizing Yes and No in the follow-up query 104b spoken by the user. Notably, the response 165 including the question solicits the user to speak the first term or the second term without explicitly specifying the first term or the second term in the response. While the example shown depicts the first term including one of “Yes” or “No” and the second term including the other one of “Yes” or “No”, the first and second terms may include terms other than “Yes” and “No” without departing from the scope of the present disclosure. Moreover, while the example only depicts only two possible terms predicted by the predictor 190 of the assistant LLM 160, the assistant LLM 160 may predict additional possible terms 192 that the user 104 may speak in the follow-on query 104b to the response 165 of “Sure, I'd love to tell a bedtime story! Do you want to hear another spooky one?”, such as “sure”, “ok”, and/or “nope”. Thereafter, during the user turn subsequent to the assistant turn in the voice-based conversation, the conversational application 105 receives additional audio data 142 characterizing the follow-up query 104b of “Yes” to the response 165 of “Sure, I'd love to tell a bedtime story! Do you want to hear another spooky one?” and the ASR model 200 biased toward recognizing the one or more possible terms 192 (e.g., “Yes” and “No”) processes the additional audio data to generate a transcription 146 of the follow-on query 104b. The ASR model 200 may then feed the transcription 146 of the follow-on query 104b to assistant LLM 160 to prompt the assistant LLM 160 to commence generating a response 165 that includes a bedtime story with a spooky theme.

In addition to, or in lieu, of predicting possible terms 192 the user 102 may speak in the follow-on query 104b, the predictor 190 of the assistant LLM 160 may process the textual representation of the response 165 to determine an expectation of a type of query 104 or a number range of words the user 102 will speak during the next user turn after the response 165 is output to the user 104. For instance, the predictor 190 may process the textual representation of the response 165 of “Sure, I'd love to tell a bedtime story! Do you want to hear another spooky one?” and determine the expectation of a short follow-up query (e.g., less than five words) based on presence of the “?” in the response 165. In other example, predictor 190 may determine the expectation of the follow-up query including dictated speech. Similarly, the predictor 190 could process a textual representation of another response 165 of “To practice your Spanish, please do your best to speak ‘Summer is my favorite season’ in Spanish” and determine the expectation that the follow-up query will include speech spoken in the language Spanish. Here, the ASR model 200 is a multilingual ASR model and the LLM 160 could provide a language identifier indicating that the ASR model 200 should bias toward recognizing Spanish.

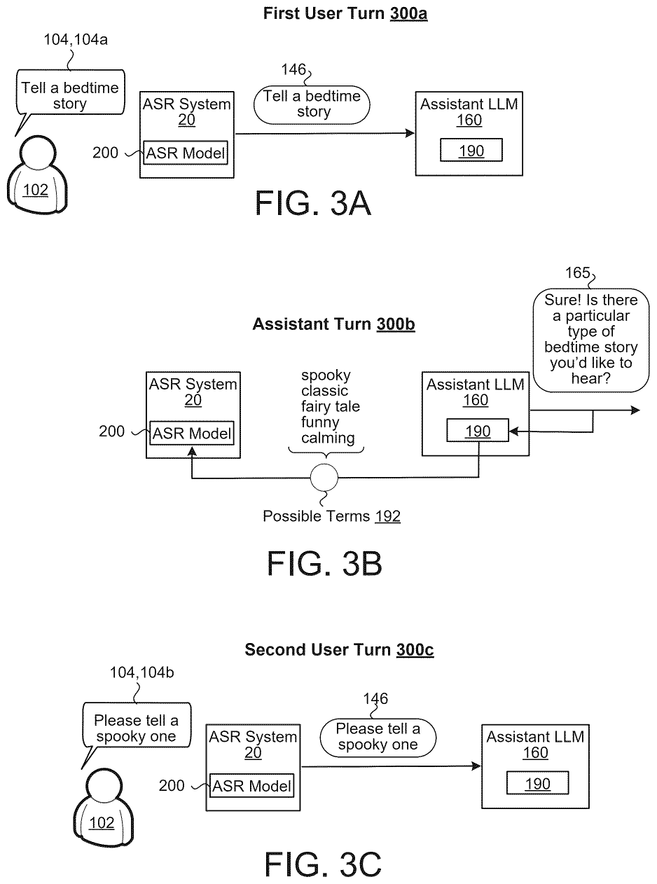

In another example, FIGS. 3A-3C provide schematic views of user and assistant turns 300a-c during another voice-based conversation between the user 102 and the assistant LLM 160. Referring to FIG. 3A, during a first user turn 300a in the voice-based conversation, the user 10 speaks a first query 104a of “Tell a bedtime story” directed toward the assistant LLM 160. The ASR model 200 processes audio data 142 characterizing the first query 104a to generate a transcription 146 of the first query 104a. Thereafter, the ASR model 200 feeds the transcription 146 of the first query 104a to the assistant LLM 160 to initiate a next assistant turn 300b.

Referring to FIG. 3B, during the assistant turn 300b in the voice-based conversation, the assistant LLM 160 processes the transcription 146 of the first query 104a to generate a response 165 of “Sure! Is there a particular type of bedtime story you'd like to hear?”. While not shown, the response 165 may be provided to the user interface 170 for audibly outputting TTS audio 172 that conveys the response 165 as synthesized speech and/or graphically displaying the response 165 as text. After generating the response 165, the predictor 190 processes a textual representation of the response 165 to determine that the response 165 includes a question that solicits the user to speak an answer to the question and identify a list of likely answers to the question. In the example shown, based on the response 165 requesting the user 102 to input a particular type of story, the predictor 192 generates the list of likely answers to include different types of bedtime stories such as spooky, classic, fairy tale, funny, calming, etc. . . . Accordingly, the assistant LLM 160 determines the one or more possible terms 192 the user 102 may speak in a follow-up query as the list of likely answers to the question and biases the ASR model 200 to bias the ASR model 200 toward recognizing the possible terms 192 that includes the list of likely answers pertaining to different types of bedtime stories.

Referring to FIG. 3C, during a second user turn 300c subsequent to the assistant turn 300b in the voice-based conversation, the user 102 speaks a second query 104b of “Please tell a spooky one” directed toward the assistant LLM indicating that the user 102 would like the assistant LLM 160 to tell a spooky bedtime story. Here, the ASR model 200 biased toward recognizing the possible terms 182 that includes the list of likely answers (e.g., spooky, classic, fairy tale, funny, calming) processes audio data characterizing the follow-up query 104b to generate a transcription 146 of the second query 104b. Thereafter, the ASR model 200 feeds the transcription 146 of the second query 104b to the assistant LLM 160 to prompt the assistant LLM 160 to commence generating the bedtime story with the spooky them during a subsequent assistant turn in the voice-based conversation.

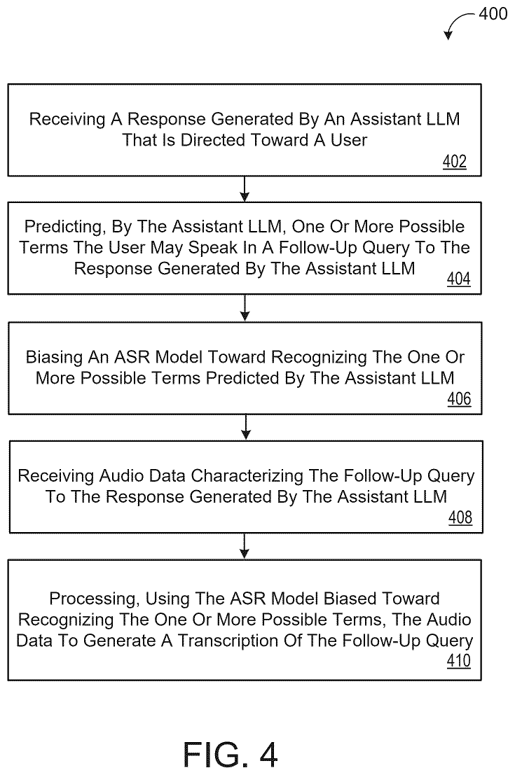

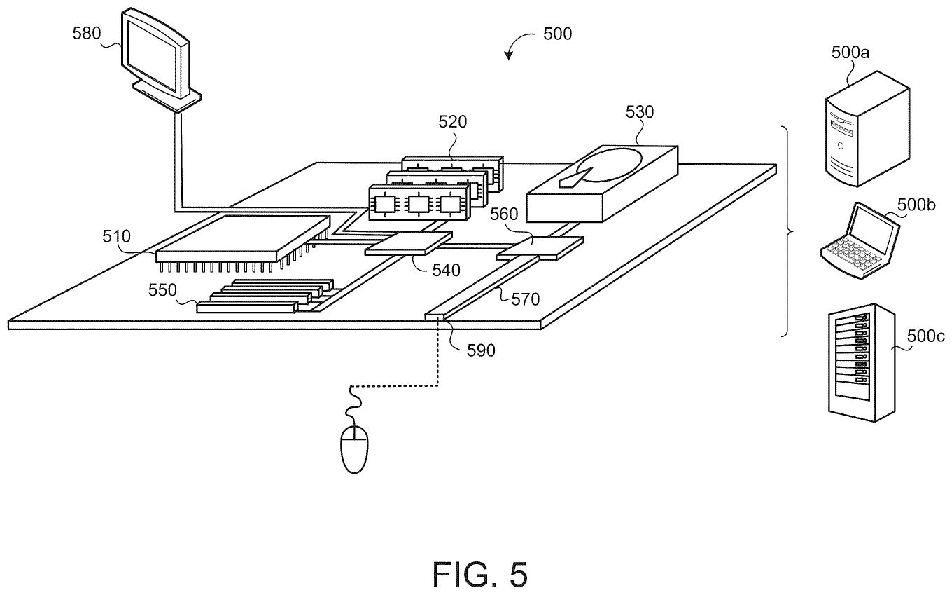

FIG. 4 includes a flowchart of an example arrangement of operations for a computer-implemented 400 of biasing an ASR model 200 during a voice-based conversation between a user 102 and an assistant LLM 160. The method 400 may execute on data processing hardware 510 (FIG. 5) using instructions stored on memory hardware 520 (FIG. 5) that may reside on the user device 110 and/or the remote system 120 of FIG. 1 each corresponding to a computing device 500 (FIG. 5).

At operation 402, during an assistant turn in the voice-based conversation between the user and the assistant LLM, the method 400 includes receiving a response 165 generated by the assistant LLM 160 that is directed toward the user. At operation 404, based on the response 165 generated by the assistant LLM 160 that is directed toward the user, the method 400 includes predicting, by the assistant LLM 160, one or more possible terms 192 the user may speak in a follow-up query 104 to the response 165 generated by the assistant LLM 165 during a user turn subsequent to the assistant turn in the voice-based conversation.

At operation 406, the method 400 includes biasing the ASR model 200 toward recognizing the one or more possible terms 192 predicted by the assistant LLM 160. At operation 408, during the user turn subsequent to the assistant turn in the voice-based conversation, the method 400 includes receiving audio data 142 characterizing the follow-up query 104 to the response 165 generated by the assistant LLM 160. At operation 410, the method 400 includes processing, using the ASR model 200 biased toward recognizing the one or more possible terms 192 predicted by the assistant LLM 160, the audio data 142 to generate a transcription 146 of the follow-up query 104.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executing on data processing hardware that causes the data processing hardware to perform operations comprising:
during an assistant turn in a voice-based conversation between a user and an assistant large language model (LLM), receiving a response generated by the assistant LLM that is directed toward the user;
based on the response generated by the assistant LLM that is directed toward the user, predicting, by the assistant LLM, one or more possible terms the user may speak in a follow-up query to the response generated by the assistant LLM during a user turn subsequent to the assistant turn in the voice-based conversation;
biasing an automated speech recognition (ASR) model toward recognizing the one or more possible terms predicted by the assistant LLM;
during the user turn subsequent to the assistant turn in the voice-based conversation, receiving audio data characterizing the follow-up query to the response generated by the assistant LLM; and
processing, using the ASR model biased toward recognizing the one or more possible terms predicted by the assistant LLM, the audio data to generate a transcription of the follow-up query.

2. The computer-implemented method of claim 1, wherein predicting the one or more possible terms the user may speak in the follow-up query comprises:
processing a textual representation of the response to:
determine that the response directed toward the user comprises a question that solicits the user to speak an answer to the question; and
identify a list of likely answers to the question; and
determining the one or more possible terms the user may speak in the follow-up query as the list of likely answers to the question.

3. The computer-implemented method of claim 1, wherein predicting the one or more possible terms the user may speak in the follow-up query comprises:
processing a textual representation of the response to determine the response comprises a question directed toward the user that solicits the user to speak a first term or a second term in the follow-up query; and
determining the one or more possible terms the user may speak in the follow-up query comprises the first term and the second term.

4. The computer-implemented method of claim 3, wherein:
the first term comprises one of Yes or No; and
the second term comprises the other one of Yes or No.

5. The computer-implemented method of claim 3, wherein the response comprising the question directed toward the user solicits the user to speak the first term or the second term without specifying the first term and the second term in the response.

6. The computer-implemented method of claim 1, wherein the operations further comprise:
obtaining, from the assistant LLM, a conversation history of the voice-based conversation comprising all previous queries input by the user and corresponding responses returned by the assistant LLM during the voice-based conversation,
wherein biasing the ASR model toward recognizing the one or more possible terms predicted by the assistant LLM further comprises biasing the ASR model toward recognizing biasing terms related to the conversation history of the voice-based conversation.

7. The computer-implemented method of claim 6, wherein the one or more possible terms predicted by the assistant LLM are different from the biasing terms related to the conversation history.

8. The computer-implemented method of claim 1, wherein the operations further comprise, after generating the transcription of the follow-up query, processing, by the assistant LLM, the transcription of the follow-up query to generate another response directed toward the user that is responsive to the follow-up query.

9. The computer-implemented method of claim 1, wherein the operations further comprise:
processing, by a text-to-speech (TTS) system, a textual representation of the response generated by assistant LLM to generate TTS audio characterizing a synthesized speech representation of the response; and
providing, for audible output from a user device associated with the user, the TTS audio characterizing the synthesized speech representation of the response.

10. The computer-implemented method of claim 1, wherein:
the ASR model comprises:
an acoustic encoder; and
a speech decoder;
the assistant LLM comprises a plurality of pre-trained multi-head attention layers; and
the ASR model and the plurality of pre-trained multi-head attention layers are trained separately.

11. A system comprising:
data processing hardware; and
memory hardware in communication with the data processing hardware, the memory hardware storing instructions that when executed on the data processing hardware cause the data processing hardware to perform operations comprising:
during an assistant turn in a voice-based conversation between a user and an assistant large language model (LLM), receiving a response generated by the assistant LLM that is directed toward the user;
based on the response generated by the assistant LLM that is directed toward the user, predicting, by the assistant LLM, one or more possible terms the user may speak in a follow-up query to the response generated by the assistant LLM during a user turn subsequent to the assistant turn in the voice-based conversation;
biasing an automated speech recognition (ASR) model toward recognizing the one or more possible terms predicted by the assistant LLM;
during the user turn subsequent to the assistant turn in the voice-based conversation, receiving audio data characterizing the follow-up query to the response generated by the assistant LLM; and
processing, using the ASR model biased toward recognizing the one or more possible terms predicted by the assistant LLM, the audio data to generate a transcription of the follow-up query.

12. The system of claim 11, wherein predicting the one or more possible terms the user may speak in the follow-up query comprises:
processing a textual representation of the response to:
determine that the response directed toward the user comprises a question that solicits the user to speak an answer to the question; and
identify a list of likely answers to the question; and
determining the one or more possible terms the user may speak in the follow-up query as the list of likely answers to the question.

13. The system of claim 11, wherein predicting the one or more possible terms the user may speak in the follow-up query comprises:
processing a textual representation of the response to determine the response comprises a question directed toward the user that solicits the user to speak a first term or a second term in the follow-up query; and
determining the one or more possible terms the user may speak in the follow-up query comprises the first term and the second term.

14. The system of claim 13, wherein:
the first term comprises one of Yes or No; and
the second term comprises the other one of Yes or No.

15. The system of claim 13, wherein the response comprising the question directed toward the user solicits the user to speak the first term or the second term without specifying the first term and the second term in the response.

16. The system of claim 11, wherein the operations further comprise:
obtaining, from the assistant LLM, a conversation history of the voice-based conversation comprising all previous queries input by the user and corresponding responses returned by the assistant LLM during the voice-based conversation,
wherein biasing the ASR model toward recognizing the one or more possible terms predicted by the assistant LLM further comprises biasing the ASR model toward recognizing biasing terms related to the conversation history of the voice-based conversation.

17. The system of claim 16, wherein the one or more possible terms predicted by the assistant LLM are different from the biasing terms related to the conversation history.

18. The system of claim 11, wherein the operations further comprise, after generating the transcription of the follow-up query, processing, by the assistant LLM, the transcription of the follow-up query to generate another response directed toward the user that is responsive to the follow-up query.

19. The system of claim 11, wherein the operations further comprise:
processing, by a text-to-speech (TTS) system, a textual representation of the response generated by assistant LLM to generate TTS audio characterizing a synthesized speech representation of the response; and
providing, for audible output from a user device associated with the user, the TTS audio characterizing the synthesized speech representation of the response.

20. The system of claim 11, wherein:
the ASR model comprises:
an acoustic encoder; and
a speech decoder;
the assistant LLM comprises a plurality of pre-trained multi-head attention layers; and
the ASR model and the plurality of pre-trained multi-head attention layers are trained separately.
